(19) United States
(12) Patent Application Publication
(10) Pub. No.: US 2006/0059523 A1
(43) Pub. Date: Mar. 16, 2006

(54) Receiving and bridging broadband access signals for wired and wireless redistribution

(75) Inventors: Jeyhan Karaoguz, Irvine, CA (US); James Bennett, San Clemente, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/937,322

(22) Filed: Sep. 10, 2004

(51) Int. Cl. H04N 7/20; H04N 7/18

(52) U.S. Cl. 725/71; 725/63; 725/80; 725/81

(57) ABSTRACT

A method for processing and redistributing multiple signals is disclosed. The method includes the steps of receiving an input data signal, wherein at least a portion of the input data signal contains data received from a broadband access antenna, analyzing the input data signal, bridging at least a portion of the input data signal into a different protocol for redistribution and providing the bridged portion to one of a wired networking mode and a wireless networking mode to be redistributed.

### FIELD OF INVENTION

The present invention relates to broadband access to data through multiple mechanisms in a home or business. In particular, the present invention is directed to bridging differing types of broadband communication and allowing for redistribution of that communication through multiple means.

### DESCRIPTION OF RELATED ART

The availability of the distribution of programming in the United States and abroad via satellite is ubiquitous. Consumers position a satellite dish, or have the same installed, to communicate with satellites that are in geosynchronous orbit and are able to send and/or receive data. Different types of satellite dishes can be used, based on the provider of satellite data, as well as on the number of satellites that are to be received by the satellite dish antenna. Currently, such data has an approximate downstream, i.e. from the satellite to the satellite receiver connected to the satellite dish, throughput of about 40 megabit per second. This allows for the receiver to readily receive data, such as television schedule data, as well as video and other programming, and to display that data to the end user. There are at present many different types of satellite services providing satellite television programming, as well services providing Internet access through satellite communication.

However, the upstream, i.e. from the receiver to the satellite, speeds are much less. The upstream path, through, for example, the Ka-band, provides only for low bandwidth at rates of approximately 3 MHz. The disjoint upstream and downstream paths are understandable because of the number of users of the service. In other words, there are many end users seeking to receive the same data, i.e. television programming, and the need to send data upstream at a rate similar to the downstream rate is not present. Thus, while the difference in the upstream and downstream rates poses no real problem for satellite television, the difference becomes a distinct disadvantage if a user sought to use the satellite infrastructure to send and receive data at parity rates.

Thus, there exist many satellite television users that have the capacity to receive high speed data, i.e. their satellite systems, but must utilize other means to provide Internet access or send data upstream. Such access could be through dialup connections or through Digital Subscriber Line (DSL) or cable modems. All of those options require additional wiring or limit the access rate. In satellite based Internet access, the above-discussed disparity in upstream and downstream rates usually requires for a user having such satellite based Internet access to have an additional upstream path, such as through DSL or cable modems. This creates a dichotomy for the end user in that the user must have dealings with both satellite service providers and cable service providers, where the providers distribute overlapping services.

Additionally, other types of high speed data access are also being developed. One such technology is covered through various incarnations of Institute of Electrical and Electronics Engineers (IEEE) 802.16 standard. Such access is often referred to as broadband access, Wimax or fixed broadband wireless. IEEE 802.16 is a specification for fixed broadband wireless networks that use a point-to-multipoint architecture. The standard defines the use of bandwidth between the licensed 10 GHz and 66 GHz and between the 2 GHZ and 11 GHz (licensed and unlicensed) frequency ranges and defines a Media Access Control (MAC) layer that supports multiple physical layer specifications customized for the frequency band of use and their associated regulations. 802.16, depending on the embodiment, supports data rates of between 32-134 Mbps at 28 MHz channels, up to 75 Mbps at 20 MHz channels or up to 15 Mbps at 5 MHz channels. 802.16 supports these very high bit rates in both uploading to and downloading from a base station up to a distance of 30 miles to handle such services as Internet Protocol (IP) connectivity, Voice over IP, and Time Division Multiplexing (TDM) voice and data.

However, for most incarnations of wireless broadband access, there is need for an additional antenna to receive the signal. Additionally, in some types of broadband access, there is a need for a line-of-sight between the source and the receiving antenna, often requiring that the antenna for broadband access to external to a home or office and requiring that the antenna to be directionally configurable to receive the signal. Even with multiple types of data access provided to the end user, such as access provided by both broadband access and satellite antennas, these access methodologies are not readily combinable. Also, even if the access methodologies are somehow combined, there is no mechanism that can handle and/or redistribute the combined signals. Thus, there is a need in the prior art for systems that allow for bridging differing types of broadband communication and allowing for redistribution of that communication through multiple means

### SUMMARY OF THE INVENTION

According to one embodiment of the invention, a method for processing and redistributing multiple signals is disclosed. The method includes the steps of receiving an input data signal, wherein at least a portion of the input data signal contains data received from a broadband access antenna, analyzing the input, data signal, bridging at least a portion of the input data signal into a different protocol for redistribution and providing the bridged portion to one of a wired networking mode and a wireless networking mode to be redistributed.

Additionally, the method may include providing an additional portion of the received data signal to a data output device, where the additional portion may come from a satellite antenna. The system may provide data received from the satellite antenna to a television receiver and supplemental data to a television receiver to supplement data received from the satellite antenna.

In addition, the method may also include downconverting a received satellite signal to provide the portion of the input data signal that contains data received from a broadband access antenna. Also, the downconverting, receiving, analyzing, bridging and providing steps may all be performed in a downconversion module proximate to the broadband access antenna. Additionally, the bridged portion may be provided to a wired Ethernet networking mode, a short-range radio technology networking mode or a wireless local area networking mode with for redistribution.

According to another embodiment, a module for processing and redistributing multiple signals is disclosed. The module includes receiving means for receiving an input data signal, wherein at least a portion of the input data signal contains data received from a broadband access antenna, analyzing means for analyzing the input data signal, bridging means for bridging at least a portion of the input data signal into a different protocol for redistribution and providing means for providing the bridged portion to one of a wired networking mode and a wireless networking mode to be redistributed.

According to another embodiment, a set top box is disclosed. The set top box includes an input port, configured to receive data from a broadband access antenna, a processing module, configured to analyze the data, at least one adaptor module, configured to bridge at least a portion of the data into a different protocol for redistribution and an output port, configured to provide the bridged portion to one of a wired networking mode and a wireless networking mode to be redistributed.

These and other variations of the present invention will be described in or be apparent from the following description of the preferred embodiments.

### BRIEF DESCRIPTION OF THE DRAWINGS

For the present invention to be easily understood and readily practiced, the present invention will now be described, for purposes of illustration and not limitation, in conjunction with the following figures:

FIG. 1 provides an illustration of a combined satellite antenna and broadband access antenna and associated circuitry and wiring, according to one embodiment of the present invention;

FIG. 2 illustrates a downconverter for converting signals received from the antennas and supplying them internally to the home or office, according to one embodiment of the present invention;

FIG. 3 illustrates a schematic of a set top box or other component, according to one embodiment of the present invention; and

FIG. 4 illustrates the process of bridging between different physical layers, according to one embodiment of the present invention.

### DETAILED DESCRIPTION OF PREFERRED EMBODIMENTS

In embodiments of the present invention discussed herein, data signals from several broadband sources are received and a determination is made as to how the signals should be processed and/or redistributed. In several embodiments, the data source is from broadband access signals received through an antenna, and signals that are translated into wired and wireless networking protocols for use in a home or office. The process and redistribution can also occur, for example, when both broadband access signals and satellite television signals are received by a set top box and distributed according to the purposes of those signals. This redistribution of broadband access signals can also occur near to the antenna receiving the broadband access signals so that wireless access may be used at that point. A specific example of receipt of both broadband access signals and satellite television signals is discussed below as an exemplary embodiment.

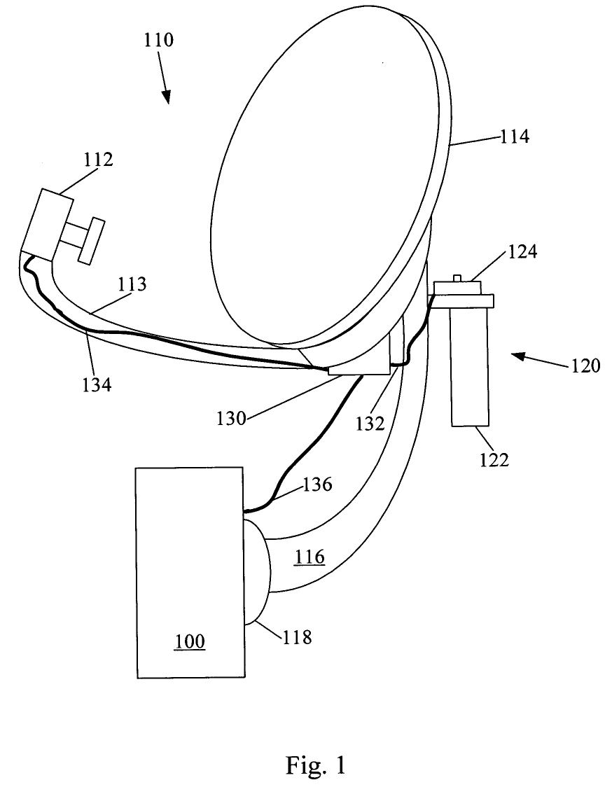

A combined satellite antenna and broadband access antenna, according to one embodiment, is illustrated in FIG. 1. The appearance of the elements is for illustrative purposes only, and is not intended to be limiting. Satellite antenna 110 has a dish or collimating section 114 and at least one low noise converter (LNC) 112, supported by arm 113, where the LNC is focused at one of the foci of the dish. LNC 112 acts to convert a received signal to the 950-2150 MHz range and amplified that signal. The amplified signal is sent, along cabling 134, to a downconverter 130. The downconverter does a further conversion of the signal and sends the signal to at least the building along cable 136.

The satellite antenna 110 is supported to an attachment support 116, which affixes the satellite antenna to a support 100. The support 100 can be a portion of a building housing the satellite receiver or may be a pole if the satellite antenna needs to be so mounted to receive a signal from the proper satellite. The attachment support 116 is connected to the support 100 through an adjustable connector 118 the adjustable connector allows for partial positioning of the satellite antenna to receive signals from the satellite. Additional adjustment mechanisms, not illustrated, are provided closer to the dish portion 114 to allow for positioning over additional degrees of freedom.

Also illustrated in the combined antenna assembly is a broadband access antenna 120. According to certain embodiments of the invention, the broadband access antenna is affixed to the support sections of the satellite antenna 110. Alternatively, the broadband access antenna could be mounted next to but not attached to the satellite antenna. Additionally, while FIG. 1 illustrates the broadband access antenna being attached to a section of the attachment support 116, the broadband access antenna can be attached to any stable portion of the satellite antenna. The broadband access antenna 120 includes a transmission and receive section 122 and an adjustment mechanism 124. The adjustment mechanism allows for the transmission and receive section to be aimed at the source of the broadband access transmitter. The signal received through the broadband access antenna is carried to the downconverter 130 through a cable 132.

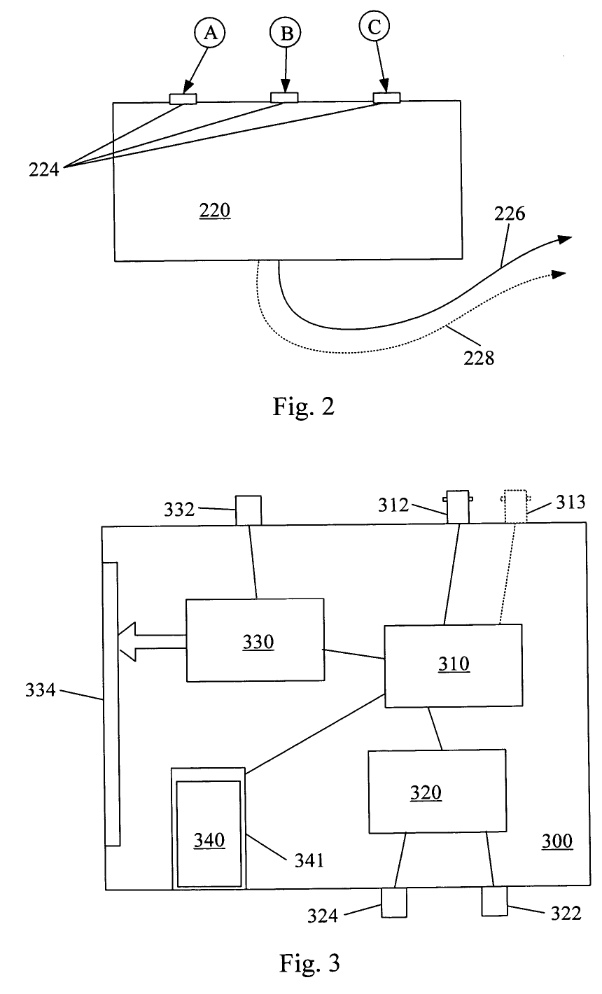

FIG. 2 illustrates a simplified schematic of a downconverter 220, according to an embodiment of the present invention. The downconverter has multiple input ports 224 for receiving signals from several antenna sources. The downconverter allows the received signals to be shifted to another frequency to avoid loss during transmission along the cabling to the receiver or other component. The signals may also be multiplexed and sent along a single cable 226 to be used by components. While in certain embodiments of the present invention a single cable is used for simplicity and economy, additional cables 228 may also be used to output the downconverted signals. One reason for such additional cabling may be a requirement that the signals being separated by some distances, or similar reason.

After the signals have been downconverted by the downconverter 130, they are then sent to the home or office through cable 136. Thereafter, the signals are sent to a set top box 300, such as the one illustrated in FIG. 3. The signals may be received at an input port 312, where the embodiment illustrated shows the input as a BNC type connector. In alternate embodiments, the set top box 300 may also have a second input port 313, where that port may receive a second signal from the antenna assembly or some other source to be processed by the set top box. The signals are processed by a processor 310, that acts to process and identify the signal being received. Based on the processing, the signals are shunted to adaptors in the set top box. For example, signals may be shunted to adaptor 320 where they may be passed to a coupler 324 or broadcast through an antenna connector 322. Such process may occur where the broadband access signals are received by the set top box 300 and sent to processor 320 for redistribution. Such redistribution could be through wired Ethernet, for example, through coupler 324 or distributed wirelessly, where that wireless distribution may be through BLUETOOTH or some form of distribution through an IEEE 802.11 network, for example. Although an antenna connector 322 is illustrated in FIG. 3, distribution through a wireless network can also be accomplished through an antenna internal to the set top box.

Additionally, signals received by the set top box can also be shunted to an audio/video adaptor 330. Such would be the case for satellite television signals received through the input 312 or 313. For distribution of such signals, as in, for example, video programming, the signal could be output through a back plane of connectors 334, where connections to audio and video equipment can be made. For the sake of compatibility, the set top box should also be able to receive signals through an input 332 that are externally produced audio/video signals.

The set top box 300 can also have at least one PC card slot 341 that allows for PC card adaptors 340 to be inserted to provide additional functionalities. This also allows for adaptors to be quickly switched out to quickly adapt the set top box to provide the processing and redistribution needed.

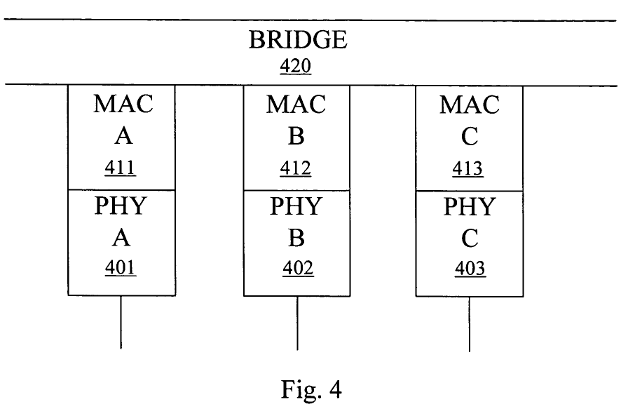

The processors and adaptors may be configured to provide all types of conversions from broadband access signals to all sort of protocols. In general, the conversion facility of the set top box would treat all signals equally and would allow for signals to be bridged between various PHYs. This is illustrated in FIG. 4, where the physical layers of different protocols are bridged. Each stack is composed of a PHY layer (401-403) and a MAC layer (411-413). Above each MAC layer is a Bridge layer 420 that allows for bridging between the PHYs through multiple pathways. Thus, signals received at PHY A can be bridged and forwarded through PHY B or PHY C, as desired. While three stacks are illustrated in FIG. 4, the present invention is not so limited and the number of stacks is selected to produce that functionalities that are needed.

As discussed above, the bridging that occurs in the set top box may be accomplished through a series of the protocol stacks. Each adaptor would be associated with a different protocol stack and bridging between those stacks would occur at a certain level. This can be accomplished through a common protocol stack that would allow for data to be bridged between distribution methodologies. The bridging can occur well below the application layer just above the PHY layers.

Additionally, the conversion facility may be incorporated into a satellite receiver to provide data coordination. Thus, in that embodiment, broadband access signals would be received along with signals from the satellite antenna, and the same wiring would be used to couple the antennas to the satellite receiver. This would also provide a benefit when used in conjunction with satellite communication because of the limit in the upstream bandwidth in consumer satellite communication.

Additionally, the invention may also be practiced by converting the received broadband access signals at the point of down-conversion, with the redistribution occurring nearby the antenna structures. For example, the bridging functions of the present invention may be incorporated when the broadband access signal is down converted and then, for example converted for distribution by wired Ethernet. The converted data could then be distributed to an access point for distribution through radio frequencies. Therefore, for that example, the broadband access signal may be converted to be used in a wireless network inside of the home or office, such as IEEE 802.11b or 802.11g.

Although embodiments of the present invention have been discussed with respect to physical components, the present invention is not so limited. All or part of the functionalities of the present invention may be accomplished solely or partially through software.

Although the invention has been described based upon these preferred embodiments, it would be apparent to those skilled in the art that certain modifications, variations, and alternative constructions would be apparent, while remaining within the spirit and scope of the invention. In order to determine the metes and bounds of the invention, therefore, reference should be made to the appended claims.

1. A method for processing and redistributing multiple signals, the method comprising the steps of:
receiving an input data signal, wherein at least a portion of the input data signal contains data received from a broadband access antenna;
analyzing the input data signal;
bridging at least a portion of the input data signal into a different protocol for redistribution; and
providing the bridged portion to one of a wired networking mode and a wireless networking mode to be redistributed.

2. A method according to claim 1, further comprising the step of providing an additional portion of the received data signal to a data output device.

3. A method according to claim 2, wherein the step of receiving an input data signal comprises receiving a data signal that contains data received from a satellite antenna and wherein the step of providing an additional portion of the received data signal comprises providing data received from the satellite antenna to the data output device.

4. A method according to claim 3, wherein the step of providing data received from the satellite antenna to the data output device comprises providing data received from the satellite antenna to a television receiver.

5. A method according to claim 3, wherein the step of providing the bridged portion comprises providing supplemental data to a television receiver to supplement data received from the satellite antenna.

6. A method according to claim 1, further comprising the step of downconverting a received satellite signal to provide the portion of the input data signal that contains data received from a broadband access antenna.

7. A method according to claim 6, wherein the downconverting, receiving, analyzing, bridging and providing steps are all performed in a downconversion module proximate to the broadband access antenna.

8. A method according to claim 1, wherein the step of providing the bridged portion comprises providing the bridged portion to a wired Ethernet networking mode for redistribution.

9. A method according to claim 1, wherein the step of providing the bridged portion comprises providing the bridged portion to a short-range radio technology networking mode for redistribution.

10. A method according to claim 1, wherein the step of providing the bridged portion comprises providing the bridged portion to a wireless local area networking mode with for redistribution.

11. A module for processing and redistributing multiple signals, comprising:
receiving means for receiving an input data signal, wherein at least a portion of the input data signal contains data received from a broadband access antenna;
analyzing means for analyzing the input data signal;
bridging means for bridging at least a portion of the input data signal into a different protocol for redistribution; and
providing means for providing the bridged portion to one of a wired networking mode and a wireless networking mode to be redistributed.

12. A module according to claim 11, further comprising second providing mean for providing an additional portion of the received data signal to a data output device.

13. A module according to claim 12, wherein the receiving means comprises second receiving means for receiving a data signal that contains data received from a satellite antenna and wherein the second providing means comprises third providing means for providing data received from the satellite antenna to the data output device.

14. A module according to claim 13, wherein the third providing means comprises fourth providing means for providing data received from the satellite antenna to a television receiver.

15. A module according to claim 13, wherein the providing means comprises supplemental providing means for providing supplemental data to a television receiver to supplement data received from the satellite antenna.

16. A module according to claim 11, further comprising downconverting means for downconverting a received satellite signal to provide the portion of the input data signal that contains data received from a broadband access antenna.

17. A module according to claim 16, wherein the downconverting means, receiving means, analyzing means, bridging means and providing means are all configured in a downconversion module proximate to the broadband access antenna.

18. A module according to claim 11, wherein the providing means comprises distribution means for distributing the bridged portion to one of a wired Ethernet networking mode, a short-range radio technology networking mode and a wireless local area networking mode.

19. A module according to claim 11, further comprising a PC card receiving means for receiving a PC card.

20. A module according to claim 11, wherein the receiving means, analyzing means, bridging means and providing means are all configured in a television set top box.

21. A set top box, comprising:
an input port, configured to receive data from a broadband access antenna;
a processing module, configured to analyze the data;
at least one adaptor module, configured to bridge at least a portion of the data into a different protocol for redistribution; and
an output port, configured to provide the bridged portion to one of a wired networking mode and a wireless networking mode to be redistributed.

22. A set top box according to claim 21, further comprising a second adaptor configured to provide an additional portion of the received data signal to a data output device.

23. A set top box according to claim 22, wherein the set top box comprises a satellite receiver.

24. A set top box according to claim 23, wherein the data output device comprises a television receiver.

25. A set top box according to claim 23, wherein the output port is configured to supply supplemental data to a television receiver to supplement data received from a satellite antenna.

26. A set top box according to claim 21, wherein the set top box comprises a cable set top box.

27. A set top box according to claim 21, wherein the at least one adaptor module comprises a bridging module to bridge the portion of the data to one of a wired Ethernet networking mode, a short-range radio technology networking mode and a wireless local area networking mode.

28. A set top box according to claim 21, further comprising a PC card slot for receiving a PC card.
